(19) United States
(12) Patent Application Publication
(10) Pub. No.: US 2017/0253289 A1
(43) Pub. Date: Sep. 7, 2017

(54) Systems, Devices, and/or Methods for Managing Bicycle Transportation

(71) Applicant: Terri M. Critzer, CHESTERFIELD, VA (US)

(72) Inventor: Terri M. Critzer, CHESTERFIELD, VA (US)

(21) Appl. No.: 15/058,042

(22) Filed: Mar. 1, 2016

(51) Int. Cl. B62K 15/00; B62H 1/02; A42B 3/32; B62J 11/00

(52) U.S. Cl. CPC B62K 15/008; B62J 11/005; B62H 1/02; A42B 3/322

(57) ABSTRACT

Certain exemplary embodiments can provide a bicycle which can comprise: a front wheel, a rear wheel, a frame, a first seat brace, a second seat brace, and a seat. The frame can comprise a first section, a second section, and a third section. The system can further comprise a lockable hinge, the first lockable hinge coupled to the frame and the wheel, when opened via a single lever or pin, the lockable hinge can be constructed to allow the front wheel to be decoupled from the frame or rotated relative to the frame.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a system 1000;

FIG. 2 is a top view of an exemplary embodiment of a system 2000;

FIG. 3 is a side view of an exemplary embodiment of a system 3000; and

FIG. 4 is a flowchart of an exemplary embodiment of a method 4000.

### DETAILED DESCRIPTION

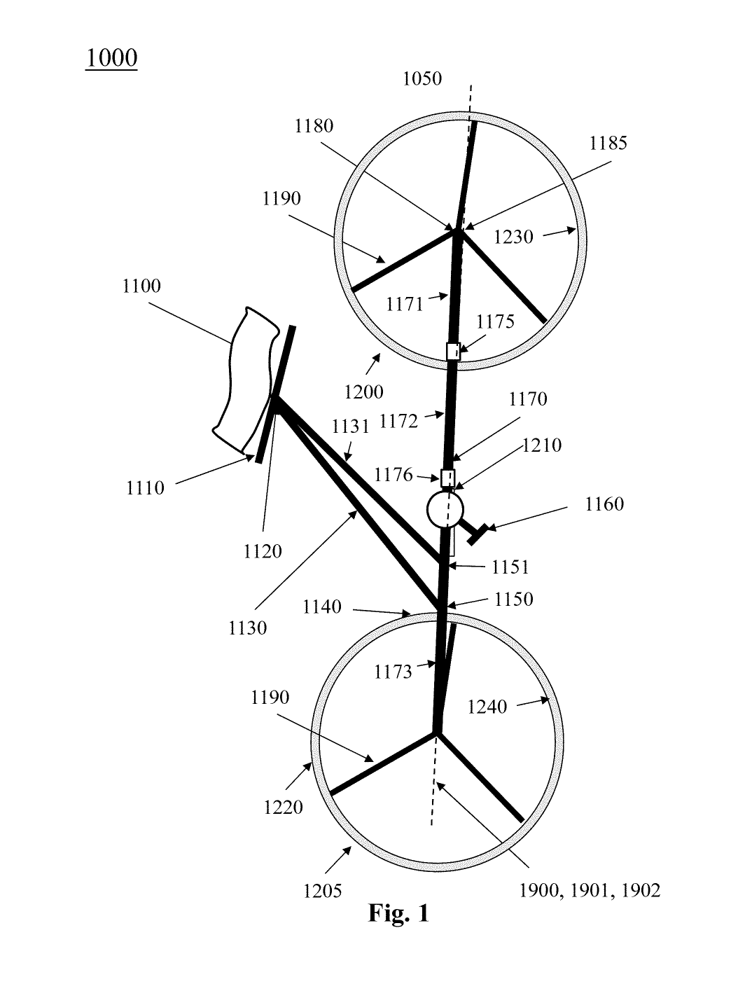

FIG. 1 is a side view of an exemplary embodiment of a system 1000, which can comprise a bicycle 1050, which can be collapsible. Bicycle 1050 can be collapsible such that, when collapsed, the bicycle can be stored and/or transported in a small space (e.g., a car trunk). For example, a set of collapsible frame connections can be released such that seat braces can be decoupled or pivotably rotated (e.g., by a releasable pinned connection) to be substantially parallel to frame 1170 for storage and/or transportation. In certain exemplary embodiments, each set of collapsible frame connections can be locked with the use of interlocking pins and additional bolts, and screws. The set of collapsible frame connections can be extended from the pivot point as illustrated in FIG. 1, frame 1170.

Frame 1170 in FIG. 1 can be released and coupled to one or more of the wheel centers to allow for bicycle 1050 to be stored or transported within a smaller unit or volume of space.

Bicycle tires 1220 will be comprised of a solid recyclable material (e.g. rubber) and can comprise carbon nanotubes. Thus, tires 1220 require no inflation at all. In other words, the tires are substantially airless. Set of wheel supports 1190 are shown for rear wheel 1205 in an exemplary configuration. Other embodiments can use a different count of wheel supports. In certain exemplary embodiments, the wheels can be spokeless. Wheel supports can have an appearance similar to that of mag wheels commonly used on automobiles. Wheel supports can be fabricated from any suitable material (e.g., aluminum). Wheel centers can comprise wheel bearings. Rear wheel 1205 comprise a sprocket and/or sheaves coupled to a set of pedals 1160. Bicycle 1050 can be driven via a chain and sprocket system or a belt and sheave system.

Bicycle 1050 can comprise:
front wheel 1200, which can comprise wheel supports 1190 and lack spokes, wheel supports 1190 can define less than approximately ten apertures between wheel supports 1190 and rim 1230 of front wheel 1200;
rear wheel 1205, which can comprise wheel supports 1190 and lack spokes, wheel supports 1190 can define less than approximately ten apertures between wheel supports 1190 and rim 1240 of rear wheel 1225;
frame 1170, which is coupleable to front wheel 1200 and rear wheel 1205, frame 1170 can comprise:
   a first section 1171;
   a second section 1172; and/or
   a third section 1173;
a first seat brace 1130, which can be coupleable to frame 1170;
a second seat brace 1131, which can be coupleable to frame 1170;
a seat 1100, which can be coupleable at least one of first seat brace 1130 and second seat brace 1131;
a first lockable hinge 1185, which can be coupled to frame 1170 and front wheel 1200, when opened via a single lever or pin, first lockable hinge 1185 can be constructed to allow front wheel 1200 to be decoupled from frame 1170;
a second lockable hinge 1175, which can be constructed to couple first section 1171 to second section 1172, when opened via a single lever or pin, second lockable hinge 1175 can be constructed to allow first section 1171 to either (1) decouple from second section 1172 or (2) rotate first section 1171 approximately 180 degrees relative to second section 1172 and a longitudinal axis of first section 1171 is substantially parallel to a longitudinal axis of second section 1172, when second lockable hinge 1175 is closed, longitudinal axis 1900 of first section 1171 is substantially collinear with longitudinal axis 1901 of second section 1172;
a third lockable hinge 1176, which can be constructed to couple second section 1172 to third section 1173, when opened via a single lever or pin, third lockable hinge 1176 constructed to allow second section 1172 to either (1) decouple from third section 1173 or (2) rotate approximately 180 degrees relative to third section 1173 and longitudinal axis 1901 of second section 1172 is substantially parallel to longitudinal axis 1902 third section, when third lockable hinge 1176 is closed, longitudinal axis 1901 of second section 1172 is substantially collinear with longitudinal axis 1902 of third section 1173;
a fourth lockable hinge 1150, which can be constructed to couple first seat brace 1130 to frame 1170, when opened via a single lever or pin, fourth lockable hinge 1150 can be constructed to allow first seat brace 1130 to be decoupled from frame 1170 or pivotably rotated relative to frame 1170;
a fifth lockable hinge 1151, fifth lockable hinge 1151 can be constructed to couple second seat brace 1131 to frame 1170, when opened via a single lever or pin, fifth lockable hinge 1151 can be constructed to allow second seat brace 1131 to be decoupled from frame 1170 or pivotably rotated relative to frame 1170;
a sixth lockable hinge 1120, which can be constructed to couple seat 1100 to at least one of first seat brace 1130 and second seat brace 1131, when opened via a single lever or pin, sixth lockable hinge 1120 can be constructed to allow seat 1100 to be decoupled from system 1000.
seat support 1110; and/or
kickstand 1210.

In certain exemplary embodiments, first section 1171 and second section 1172 are telescopic sections that, when unlocked, are constructed to be retracted within third section 1173 of frame 1170. Such embodiments can comprise:
a first lockable collar in a same approximate location as illustrated second lockable hinge 1175; the first lockable collar can be constructed to, when locked, lock first section 1171 in an extended position; and/or
a second lockable collar in a same approximate location as illustrated third lockable hinge 1176; the second lockable collar can be constructed to, when locked, lock second section 1172 in an extended position;

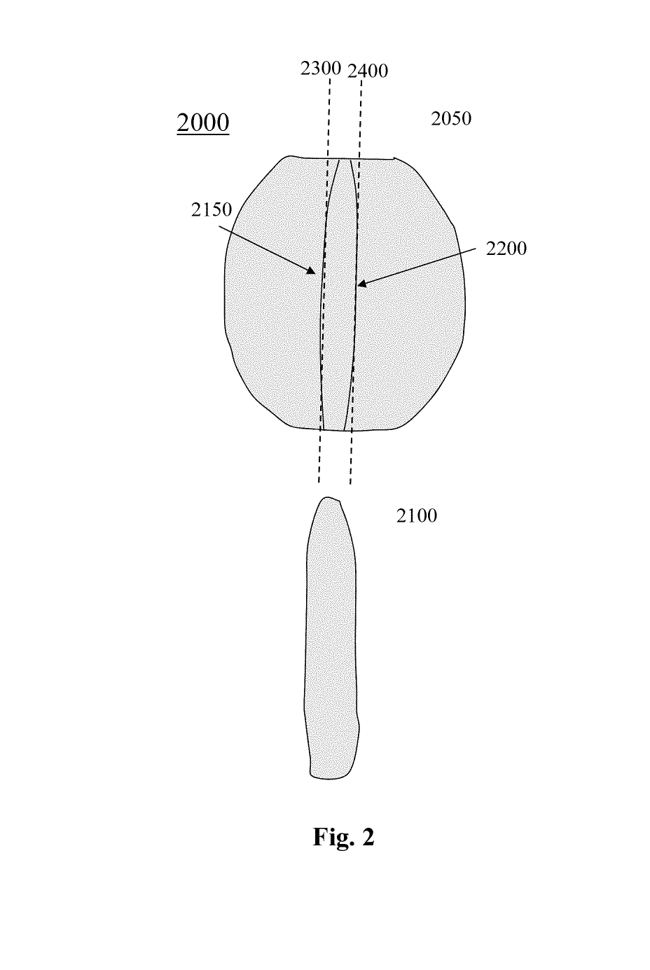

FIG. 2 is a top view of an exemplary embodiment of a system 2000, which can comprise a helmet 2050 shown in an expanded configuration. Helmet 2050 comprises a first lockable joint 2150 and a second lockable joint 2200. Helmet 2050 can be constructed to be collapsible to collapsed configuration 2100 via folding helmet 2050 along first collapsible axis 2300 and second collapsible axis 2400. When expanded, helmet 2050 can be held in an expanded configuration via a set of releasable pins. Depression and/or removal of the releasable pins can allow helmet 2050 to be collapsed. Helmet 2050 can comprise a hard material such as plastic, graphite, carbon fiber, polyurethane, polymer, microcellular foam, ceramic, and/or carbon nanotubes, etc.

In certain exemplary embodiments, helmet 2050 can be a collapsible bicycle helmet. Helmet 2050 can comprise a first lockable joint 2150 and second lockable joint 2200. Each of first lockable joint 2150 and second lockable joint 2200 can be constructed to:
when locked and when helmet is worn by a user, cushion impacts from impacting objects or surfaces; and/or
when unlocked, allow helmet 2050 to have a reduced width compared to when first lockable joint 2150 and second lockable joint 2200 are locked.

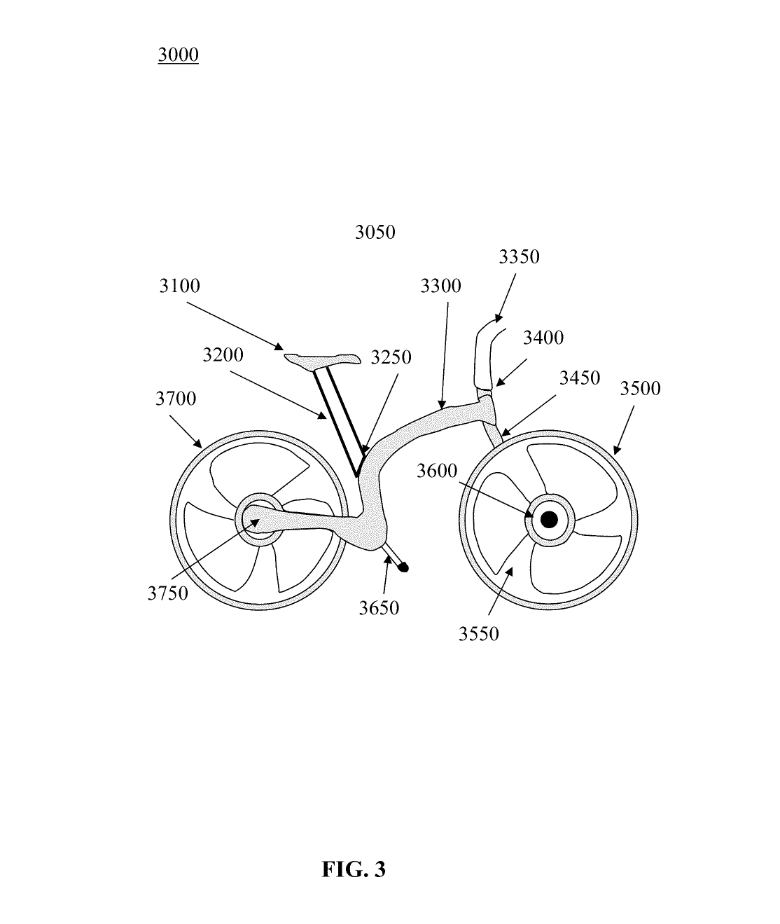

FIG. 3 is a side view of an exemplary embodiment of a system 3000, which comprises bicycle 3050. Bicycle 3050 comprises a seat 3100, a seat support 3200, a seat support junction 3250, a frame 3300, a handle bar 3350, a handle bar mount 3400, a front wheel coupler 3450, a front wheel 3500, front wheel supports 3550, front wheel bearing assembly 3600, pedal 3650, rear wheel 3700, and rear wheel drive and bearing assembly 3750.

Bicycle 3050 can be collapsible. For example, seat 3100 and/or seat support 3200 can be pivoted and/or removed relative to frame 3300 via seat support junction 3250. Handle bar 3350 can be pivoted and/or removed relative to frame 3300 via handle bar mount 3400. Frame 3300 can be pivoted and/or removed relative to front wheel 3500 via front wheel coupler 3450. Frame 3300 can be pivoted and/or removed relative to rear wheel 3700 via rear wheel drive and bearing assembly 3750. Frame 3300 can comprise one or more junction points that allow frame 3300 to be collapsed or separated into two or more sections for convenient storage and/or transportation. Energy can be transmitted from pedal 3650 to rear wheel 3700 via a chain or belt drive that is at least partially encased in frame 3300. Bicycle 3050 can be constructed to be operated by one hand of a rider of bicycle 3050.

The illustrated embodiment of FIG. 3 illustrates and embodiment with three front wheel supports 3550. In other embodiments, different wheel support counts can be utilized (e.g., five wheel supports 3550). In certain exemplary embodiments, front wheel 3500 and rear wheel 3700 can be airless. Front wheel 3500 and rear wheel 3700 can comprise a hard, yet flexible material, such as rubber, carbon fiber, polyurethane, microcellular foam, ceramic, and/or carbon nanotubes, etc.

Seat 3100 can be adaptive to fit a form of a rider of bicycle 3050. For example, seat 3100 can comprise a memory foam.

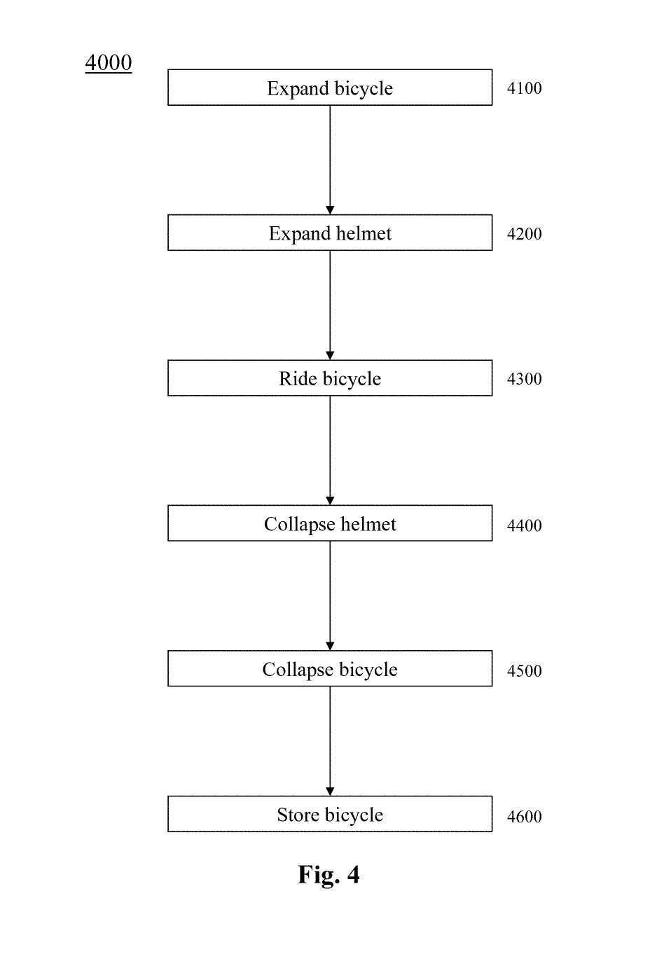

FIG. 4 is a flowchart of an exemplary embodiment of a method 4000. At activity 4100, a bicycle can be expanded from a collapsed configuration such that the bicycle is ready to ride. At activity 4200, a bicycle helmet can be expanded for use in riding the bicycle. At activity 4300, a user can wear the helmet and/or ride the bicycle. At activity 4400, the user can collapse the helmet for storage and/or transportation. At activity 4500, the bicycle can be collapsed for storage and/or transportation. At activity 4600, the bicycle can be stored and/or transported while in a collapsed state.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
allow—to permit.
and/or—either in conjunction with or in alternative to.
aperture—an opening defined by an object or coupled objects.
apparatus—an appliance or device for a particular purpose
associate—to join, connect together, and/or relate.
bicycle—a vehicle with two wheels tandem, handlebars that facilitate steering, a seat, and pedals by which the vehicle is propelled.
can—is capable of, in at least some embodiments.
collinear—having axes lying end to end in a substantially straight line.
comprising—including but not limited to.
configure—to make suitable or fit for a specific use or situation.
connect—to join or fasten together.
constructed to—made suitable or fit for a specific use or situation.
convert—to transform, adapt, and/or change.
coupleable—capable of being joined, connected, and/or linked together.
coupling—linking in some fashion.
cushion—to lessen or soften the effects of.
decouple—to unlink from a linked state.
define—to establish the outline, form, or structure of.
device—a machine, manufacture, and/or collection thereof.
front—most forward part of a normally traveling bicycle.
frame—a structure that maintains spacing between a front wheel, a rear wheel, and a seat of a bicycle when in an operative configuration.
hinge—a jointed or flexible device on a swinging part turns.
impact—a striking of one thing against another.
install—to connect or set in position and prepare for use.
helmet—a protective head covering made of a hard material to resist impact.
hinge—a jointed or flexible device on which a swinging part turns.
joint—a place where to parts of something are coupled together.
kickstand—a swiveling metal bar or rod attached to a bicycle and used to prop up the bicycle when it is not in use.
lever—a rigid piece of a device that transmits force or motion when forces are applied, turns about an axis, and changes a device state between locked and unlocked.
lockable—capable of being secured such that, when secured, components substantially do not move relative to one another.
longitudinal axis—A line along a longest dimension of an object that passes through the object's center of gravity.
may—is allowed and/or permitted to, in at least some embodiments.
method—a process, procedure, and/or collection of related activities for accomplishing something.
object—a material thing.
parallel—extending in a same direction.
pin—a piece of solid material (e.g., wood or metal) constructed to fasten things together.
pivotably—capable of being rotated about a point or shaft.
plurality—the state of being plural and/or more than one.
predetermined—established in advance.
provide—to furnish, supply, give, and/or make available.
rear—most backward part of a normally traveling bicycle.
receive—to get, take, acquire, and/or obtain.
reduce—to diminish in size.
repeatedly—again and again; repetitively.
rim—an outer part of a wheel joined to a hub of the wheel via one or more wheel supports.
rotate—to turn about an axis.
seat—a bicycle component constructed for a human's buttocks to be placed when riding.
seat brace—a structural member of a bicycle to which a seat mounts.
section—a distinct part of something.
set—a related plurality.
spokes—wire rods having a diameter of less than approximately 0.125 inches that connect a center of a wheel to an outer edge of the wheel.
store—to place, hold, and/or retain.
substantially—to a great extent or degree.
support—to bear the weight of, especially from below.
surface—an exterior of an object or body.
system—a collection of mechanisms, devices, machines, articles of manufacture, processes, data, and/or instructions, the collection designed to perform one or more specific functions.
telescopic—comprising parts that slide one within another like the tubes of a jointed telescope and are thus capable of being extended or shortened.
unlock—to free from a restraint.
user—a human that employs something.
via—by way of and/or utilizing.
wheel—a circular frame of hard material that may be solid, partly solid, or comprise wheel supports, and that is capable of turning on an axle.
wheel supports—structural members having a smallest cross-sectional dimension of greater than approximately 0.25 inches, which members connect a center of a wheel to an outer edge of the wheel.
width—a horizontal measurement taken substantially at right angles to a length.
worn—to have on a user.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a bicycle, said bicycle comprising:
a front wheel;
a rear wheel;
a frame, said frame coupleable to said front wheel and said rear wheel, said frame comprising a first section, a second section, and a third section;
a first seat brace, said first seat brace coupleable to said frame;
a second seat brace, said second seat brace coupleable to said frame;
a seat, said seat coupleable at least one of said first seat brace and said second seat brace;
a first lockable hinge, said first lockable hinge coupled to said frame and said front wheel, when opened via a single lever or pin, said first lockable hinge constructed to allow said front wheel to be decoupled from said frame;
a second lockable hinge, said second lockable hinge constructed to couple said first section to said second section, when opened via a single lever or pin, said second lockable hinge constructed to allow said first section to either (1) decouple from said second section or (2) rotate said first section approximately 180 degrees relative to said second section and a longitudinal axis of said first section is substantially parallel to a longitudinal axis of said second section, when said second lockable hinge is closed, said longitudinal axis of said first section substantially collinear with said longitudinal axis of said second section;
a third lockable hinge, said third lockable hinge constructed to couple said second section to said third section, when opened via a single lever or pin, said third lockable hinge constructed to allow said second section to either (1) decouple from said third section or (2) rotate approximately 180 degrees relative to said third section and said longitudinal axis of said second section is substantially parallel to a longitudinal axis of said third section, when said third lockable hinge is closed, said longitudinal axis of said second section substantially collinear with said longitudinal axis of said third section;
a fourth lockable hinge, said fourth lockable hinge constructed to couple said first seat brace to said frame, when opened via a single lever or pin, said fourth lockable hinge constructed to allow said first seat brace to be decoupled from said frame or pivotably rotated relative to said frame;
a fifth lockable hinge, said fifth lockable hinge constructed to couple said second seat brace to said frame, when opened via a single lever or pin, said fifth lockable hinge constructed to allow said second seat brace to be decoupled from said frame or pivotably rotated relative to said frame; and
a sixth lockable hinge, said sixth lockable hinge constructed to couple said seat to at least one of said first seat brace and said second seat brace, when opened via a single lever or pin, said sixth lockable hinge constructed to allow said seat to be decoupled from said system.

2. The system of claim 1, further comprising:
a kickstand.

3. The system of claim 1, further comprising:
a collapsible bicycle helmet, said collapsible bicycle helmet comprising a first lockable joint and a second lockable joint, each of said first lockable joint and said second lockable joint constructed to:
when locked and when said helmet is worn by a user, cushion impacts from impacting objects or surfaces; and
when unlocked, allow said collapsible bicycle helmet to have a reduced width compared to when said first lockable joint and said second lockable joint are locked.

4. The system of claim 1, wherein:
said front wheel and said rear wheel comprise wheel supports and lack spokes.

5. The system of claim 1, wherein:
said front wheel and said rear wheel comprise wheel supports and lack spokes, wherein said wheel supports define less than approximately ten apertures between said wheel supports and a rim of each of said front wheel and said rear wheel.

6. A system comprising:
a bicycle, said bicycle comprising:
a front wheel;
a rear wheel;
a frame, said frame coupleable to said front wheel and said rear wheel, said frame comprising a first section, a second section, and a third section, wherein said first section and said second section are telescopic sections that, when unlocked, are constructed to be retracted within said third section;
a first seat brace, said first seat brace coupleable to said frame;
a second seat brace, said second seat brace coupleable to said frame;
a seat support, said seat support coupleable to said set of seat braces;
a seat, said seat coupleable to said seat support;
a first lockable hinge, said first lockable hinge coupled to said frame and said front wheel, when opened via a single lever or pin, said first lockable hinge constructed to allow said wheel to be decoupled from said frame;
a first lockable collar, said first lockable collar constructed to, when locked, lock said first section in an extended position;
a second lockable collar, said second lockable collar constructed to, when locked, lock said second section in an extended position;
a second lockable hinge, said second lockable hinge constructed to couple said first seat brace to said frame, when opened via a single lever or pin, said second lockable hinge constructed to allow said first seat brace to be decoupled from said frame or pivotably rotated relative to said frame;
a third lockable hinge, said third lockable hinge constructed to couple said second seat brace to said frame, when opened via a single lever or pin, said third lockable hinge constructed to allow said second seat brace to be decoupled from said frame or pivotably rotated relative to said frame; and
a fourth lockable hinge, said fourth lockable hinge constructed to couple said seat to at least one of said first seat brace and said second seat brace, when opened via a single lever or pin, said fourth lockable hinge constructed to allow said seat to be decoupled from said system.
